(19) United States
(12) Patent Application Publication
(10) Pub. No.: US 2021/0111416 A1
(43) Pub. Date: Apr. 15, 2021

(54) METAL BEAD SEAL, MANUFACTURING METHOD FOR SAME, AND MANUFACTURING METHOD FOR FUEL CELLS

(71) Applicant: NOK CORPORATION, Tokyo (JP)

(72) Inventors: Yohei SANO, Kikugawa (JP); Toshihiro SHIMAZOE, Kikugawa (JP)

(21) Appl. No.: 16/970,118

(22) PCT Filed: Sep. 24, 2019
(86) PCT No.: PCT/JP2019/037400

§ 371 Date: Aug. 14, 2020

(30) Foreign Application Priority Data
Dec. 11, 2018 (JP) 2018-231660

(51) Int. Cl. H01M 8/0276; H01M 8/0282; H01M 8/0286; H01M 8/0284; B21D 22/02; F16J 15/08

(52) U.S. Cl. CPC H01M 8/0276; H01M 8/0282; F16J 15/08; H01M 8/0284; B21D 22/02; H01M 8/0286

(57) ABSTRACT

A metal bead seal with uniform sealing surface pressure and improved sealability is provided. A sealing bead is integrated with a basal part made of metal, and includes a curved part that is curved in a plan view and that includes a maximum bead width part having a maximum bead width w₁, a straight part that is straight in a plan view and continuous from the curved part, the straight part including a minimum bead width part having a minimum bead width, a gradually varying bead width part that is positioned between the maximum bead width part and the minimum bead width part, the gradually varying bead width part having its bead width continuously varied from the maximum bead width to the minimum bead width.

### CROSS REFERENCE TO RELATED APPLICATIONS

This application is a U.S. National Phase application of International Application No. PCT/JP2019/037400, filed on Sep. 24, 2019 and published in Japanese as WO 2020/121623 on Jun. 18, 2020 and claims priority to Japanese Patent Application No. 2018-231660, filed on Dec. 11, 2018. The entire disclosures of the above applications are expressly incorporated by reference herein.

### BACKGROUND

### Technical Field

The present disclosure relates to a metal bead seal, a method of manufacturing the same, and a method of manufacturing a fuel cell.

### Related Art

As a sealing structure for sealing between separators in a fuel cell, a metal bead seal has been proposed (for example, Japanese Unexamined Patent Application Publication No. 2017-139218).

As illustrated in FIGS. 7A and 7B, a conventional metal bead seal 1 includes a metal plate 11 integrated with a basal part 21 and a sealing bead 31. A sealing rubber 51 is mounted on the sealing bead 31. Sealability is effectuated using the reactive force that occurs at the sealing bead 31 in the bead height direction during assembly and the followability of the sealing rubber 51 to the surface roughness and others of the separator.

In a conventional metal bead seal 1, the magnitude of the reactive force that occurs at the sealing bead 31 is mainly determined by the cross-sectional shape of the bead. On the other hand, the effect of the shape of the sealing line (the shape of the sealing bead in a plan view) is not negligible.

Accordingly, despite being identical in cross section, a curved part (rounded part) 35 which is curved in a plan view in the sealing line and a straight part 36 which is straight in a plan view in the sealing line may vary from each other in the magnitude of the reactive force occurring at the sealing bead 31. In the curved part 35, particularly as the curvature is smaller (as the rounding is smaller), the reactive force occurring at the sealing bead 31 tends to become great, to increase the sealing surface pressure.

Accordingly, by the variations in the magnitude of the reactive force occurring at the sealing bead 31, a low reactive force part is formed. As represented in FIG. 8 as the straight part, the sealing surface pressure reduces at the low reactive force part, which may impair sealability.

An object of the present disclosure is to provide a metal bead seal with uniform sealing surface pressure and improved sealability and a method of manufacturing the same.

### SUMMARY

A first aspect of the present disclosure is a metal bead seal including:

a basal part made of metal; and

a sealing bead integrated with the basal part, the sealing bead including

a curved part that is curved in a plan view, the curved part including a maximum bead width part having a maximum bead width,

a straight part that is straight in a plan view and continuous from the curved part, the straight part including a minimum bead width part having a minimum bead width, and

a gradually varying bead width part that is positioned between the maximum bead width part and the minimum bead width part, the gradually varying bead width part having its bead width continuously varied from the maximum bead width to the minimum bead width.

A second aspect of the present disclosure is a metal bead seal including:

a basal part made of metal; and

a sealing bead integrated with the basal part, the sealing bead including

a curved part that is curved in a plan view, the curved part including a minimum bead height part having a minimum bead height,

a straight part that is straight in a plan view and continuous from the curved part, the straight part including a maximum bead height part having a maximum bead height, and

a gradually varying bead height part positioned between the minimum bead height part and the maximum bead height part, the gradually varying bead height part having its bead height continuously varied from the minimum bead height to the maximum bead height.

A third aspect of the present disclosure is a method of manufacturing a metal bead seal including:

a basal part made of metal; and

a sealing bead integrated with the basal part, the sealing bead including

a curved part that is curved in a plan view, the curved part including a maximum bead width part having a maximum bead width,

a straight part that is straight in a plan view and continuous from the curved part, the straight part including a minimum bead width part having a minimum bead width, and

a gradually varying bead width part that is positioned between the maximum bead width part and the minimum bead width part, the gradually varying bead width part having its bead width continuously varied from the maximum bead width to the minimum bead width, the method including:

providing a press die that includes a recessed part having a width corresponding to the maximum bead width part, the minimum bead width part, and the gradually varying bead width part; and

press-forming a plate-like plate using the press die.

A fourth aspect of the present disclosure is a method of manufacturing a metal bead seal including:

a basal part made of metal; and

a sealing bead integrated with the basal part, the sealing bead including

a curved part that is curved in a plan view, the curved part including a minimum bead height part having a minimum bead height,

a straight part that is straight in a plan view and continuous from the curved part, the straight part including a maximum bead height part having a maximum bead height, and

a gradually varying bead height part positioned between the minimum bead height part and the maximum bead height part, the gradually varying bead height part having its bead height continuously varied from the minimum bead height to the maximum bead height, the method including:

providing a press die (61) having a shim (68) provided at a bottom surface of an insert housing part (67) so as to correspond to the minimum bead height part (41), the maximum bead height part (42), and the gradually varying bead height part (43), and

press-forming a plate-like plate (11) using the press die (61).

A fifth aspect of the present disclosure is a method of manufacturing a fuel cell, including installing the metal bead seal into a fuel cell.

### Advantageous Effects

The metal bead seal and the method of manufacturing the same of the present disclosure attain uniform sealing surface pressure and improved sealability.

### BRIEF DESCRIPTION OF THE DRAWINGS

FIG. 1A is a plan view of a metal bead seal according to a first embodiment.

FIG. 1B is an enlarged cross-sectional view taken along line C-C in FIG. 1A.

FIG. 2 is a graph representing the relationship between the compression amount and the sealing surface pressure in the metal bead seal according to the first embodiment.

FIG. 3 is an explanatory illustration of a press die assembly for forming the metal bead seal according to the first embodiment.

FIG. 4A is a plan view of a metal bead seal according to a second embodiment.

FIG. 4B is an enlarged cross-sectional view taken along line D-D in FIG. 4A.

FIG. 5 is a graph representing the relationship between the compression amount and the sealing surface pressure in the metal bead seal according to the second embodiment.

FIG. 6 is an explanatory illustration of a press die assembly for forming the metal bead seal according to the second embodiment.

FIG. 7A is a plan view of a metal bead seal of a conventional technique.

FIG. 7B is an enlarged cross-sectional view taken along line E-E in FIG. 7A.

FIG. 8 is a graph of the relationship between the compression amount and the sealing surface pressure in the metal bead seal of the conventional technique.

### DETAILED DESCRIPTION

### First Embodiment

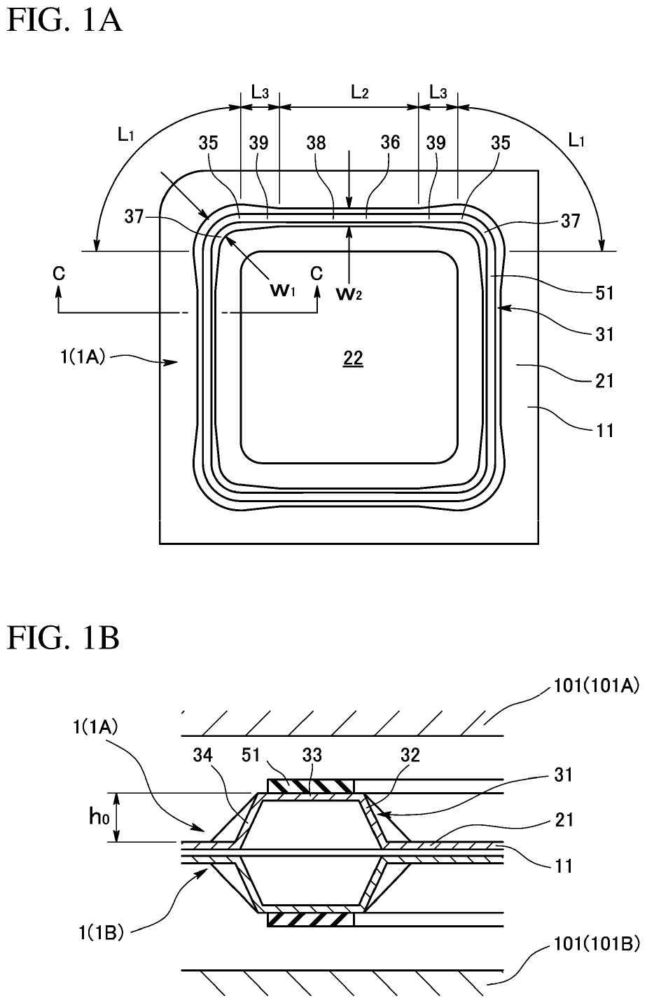

As illustrated in FIG. 1, a metal bead seal 1 according to a first embodiment includes a basal part 21 and a sealing bead 31. The basal part 21 and the sealing bead 31 are integrated with a metal plate 11. On a portion of the sealing bead 31 where the sealing bead 31 is brought into contact with a counterpart component 101, a sealing rubber 51 is mounted. Mounting the metal bead seal 1 effectuates sealability using the reactive force that occurs at the sealing bead 31 compressed in the bead height direction and the followability of the sealing rubber 51 to the surface roughness and others of the counterpart component.

The metal bead seal 1 is installed into, for example, a fuel cell, and used as a fuel cell seal for sealing fuel gas or a refrigerant. In this case, the counterpart component is, for example, a fuel cell separator 101. Furthermore, the metal bead seal 1 is mounted between a pair of separators 101A, 101B disposed on the opposite sides in the thickness direction. Thus, the metal bead seal 1 is a combination of a first metal bead seal 1A that opposes to the first separator 101A and a second metal bead seal 1B that opposes to the second separator 101B. The first metal bead seal 1A and the second metal bead seal 1B have symmetry in shape and structure in the seal thickness direction. In the following, a description will be given of just the first metal bead seal 1A, and the repetitive description of the second metal bead seal 1B will be omitted.

The plate 11 is, for example, a steel plate having a thickness of 0.05 to 0.2 mm and formed of a low-hardness material of Hv 300 or less (SUS304L or the like). The sealing rubber 51 has a thickness of 100 μm or less and is formed of, for example, silicon, SIFEL, EPDM, FKM, or PIB. The sealing rubber 51 is provided band-like along the entire circumference of the sealing bead 31.

The basal part 21 is planar and a frame-like body having hollow space 22.

The sealing bead 31 is formed into a three-dimensional shape by press forming performed on part of the plane of the basal part 21. The sealing bead 31 is formed in an endless manner along the entire circumference of the frame-like basal part 21.

The sealing bead 31 is formed as a so-called full bead. The sealing bead 31 is integrally formed of an inclined-surface-like lateral surface on the inner circumferential side (inner-circumferential lateral surface) 32, a flat top surface 33, and an inclined-surface-like lateral surface on the outer circumferential side (outer-circumferential lateral surface) 34. The sealing bead 31 is hollow and has a trapezoidal cross-sectional shape which has symmetry in the width direction.

The sealing bead 31 is rectangular in a plan view corresponding to the frame-like basal part 21. The sealing bead 31 includes a curved part (rounded part) 35 and a straight part 36. The curved part 35 is curved in a plan view and disposed at each of the four corners of the sealing bead 31. The straight part 36 is straight in a plan view and disposed at each of the four sides of the sealing bead 31. The curved part 35 and the straight part 36 are alternately disposed on the circumference of the sealing bead 31.

As illustrated in FIGS. 1A and 1B, the curved part 35 includes a maximum bead width part 37. The maximum bead width part 37 has a maximum bead width w₁ where the bead width is maximum on the circumference. The maximum bead width part 37 has a constant length range L₁ on the circumference, and is provided along the entire length (the entire angle) of the curved part 35.

The straight part 36 includes a minimum bead width part 38. The minimum bead width part 38 has a minimum bead width w₂ where the bead width is minimum on the circumference. The minimum bead width part 38 has a constant length range L₂ on the circumference, and is provided at the center in the length direction of the straight part 36.

Between the maximum bead width part 37 and the minimum bead width part 38, a gradually varying bead width part 39 is provided. The bead width of the gradually varying bead width part 39 gradually varies from the maximum bead width w₁ of the maximum bead width part 37 to the minimum bead width w₂ of the minimum bead width part 38. The gradually varying bead width part 39 has a constant length range L₃ on the circumference, and is provided at each of the opposite ends in the length direction of the straight part 36. Note that, part of the gradually varying bead width part 39 may be included in the curved part 35.

A height h₀ of the sealing bead 31 is constant over the entire circumference of the sealing bead 31. The width of the top surface 33 of the sealing bead 31 is constant over the entire circumference of the sealing bead 31.

In the following, a description will be given of the operation and effect of the metal bead seal 1 according to the present embodiment.

As in the conventional technique, when the cross-sectional shape of the sealing bead is completely the same on the circumference, the magnitude of the reactive force that occurs upon the compression of the sealing bead varies. Specifically, the reactive force increases at the curved part which is curved in a plan view and reduces at the straight part which is straight in a plan view.

On the other hand, in the sealing bead 31 according to the present embodiment, the curved part 35 includes the maximum bead width part 37 that has the maximum bead width; the straight part 36 includes the minimum bead width part 38 that has the minimum bead width; and the maximum bead width part 37 and the minimum bead width part 38 are smoothly connected to each other via the gradually varying bead width part 39.

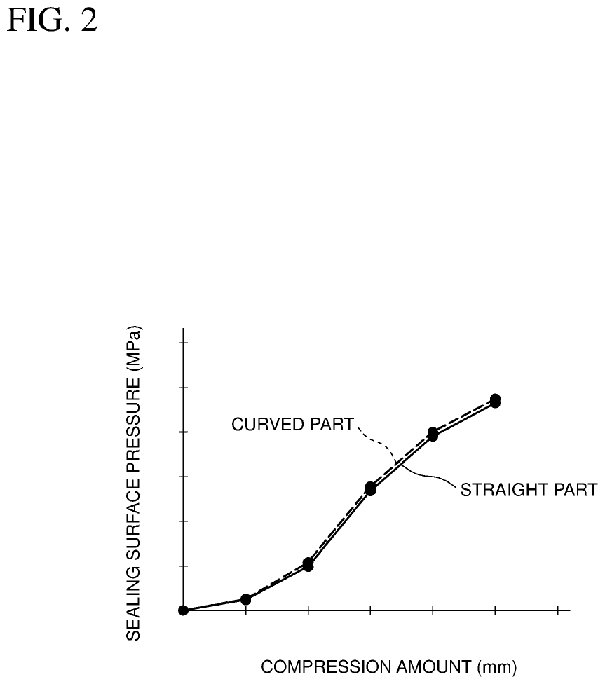

Accordingly, the magnitude of the reactive force occurring at the curved part 35 is smaller than in the conventional technique. Furthermore, the magnitude of the reactive force occurring at the straight part 36 is greater than in the conventional technique. This means that, with a constant height h₀, the occurring reactive force becomes smaller as the bead width is greater, and the occurring reactive force becomes greater as the bead width is smaller. As a result, as represented in the graph of FIG. 2, the magnitude of the reactive force occurring at the curved part 35 and the magnitude of the reactive force occurring at the straight part 36 approximate each other. Accordingly, the magnitude of the reactive force occurring at the sealing bead 31 upon compression becomes uniform as much as possible, which in turn provides uniform sealing surface pressure. This improves sealability.

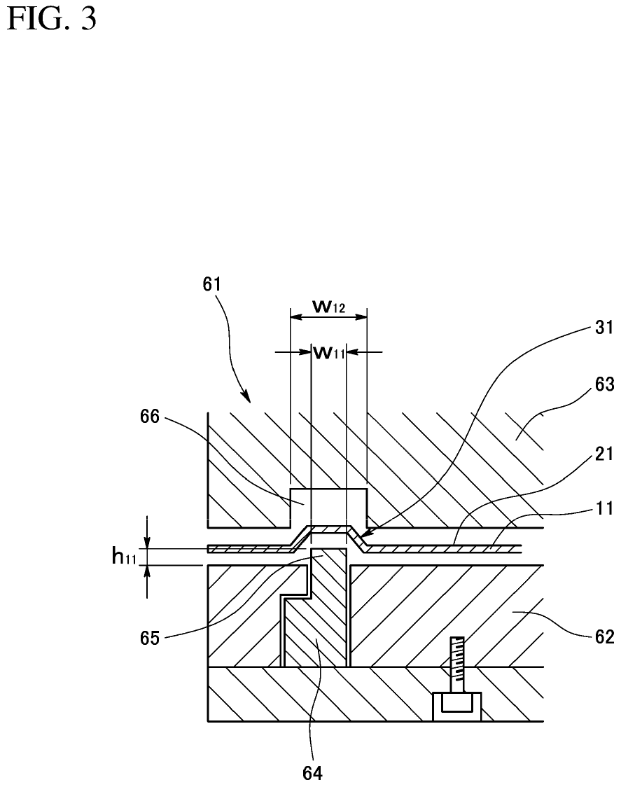

In the following, with reference to FIG. 3, a description will be given of a method of manufacturing the metal bead seal 1 according to the first embodiment. As illustrated in FIG. 3, using a press die assembly 61, the sealing bead 31 is formed at the metal plate 11.

The press die assembly 61 includes a first half die (lower die) 62 and a second half die (upper die) 63. In order to form the sealing bead 31 at the planar metal plate 11, an insert 64 including a press-purpose projecting part 65 is installed into the first half die 62. The second half die 63 is provided with a recessed part 66 as a receiver for the projecting part.

A width w₁₁ and a height h₁₁ of the projecting part 65 are constant over the entire circumference. On the other hand, a width w₁₂ of the recessed part 66 has the values corresponding to the width of each of the maximum bead width part 37, the minimum bead width part 38, and the gradually varying bead width part 39 of the sealing bead 31. That is, at a portion on the circumference corresponding to the maximum bead width part 37, the width w₁₁ of the projecting part 65 is similar to the width w₁ of the maximum bead width part 37. At a portion on the circumference corresponding to the minimum bead width part 38, the width w₁₁ of the projecting part 65 is similar to the width w₂ of the minimum bead width part 38. At a portion on the circumference corresponding to the gradually varying bead width part 39, the width w₁₁ of the projecting part 65 gradually varies similarly to the gradually varying bead width part 39.

By forming the sealing bead 31 at the plate 11 using the press die assembly 61 according to the present embodiment, the sealing bead 31 that includes the maximum bead width part 37, the minimum bead width part 38, and the gradually varying bead width part 39 on the circumference is press formed.

### Second Embodiment

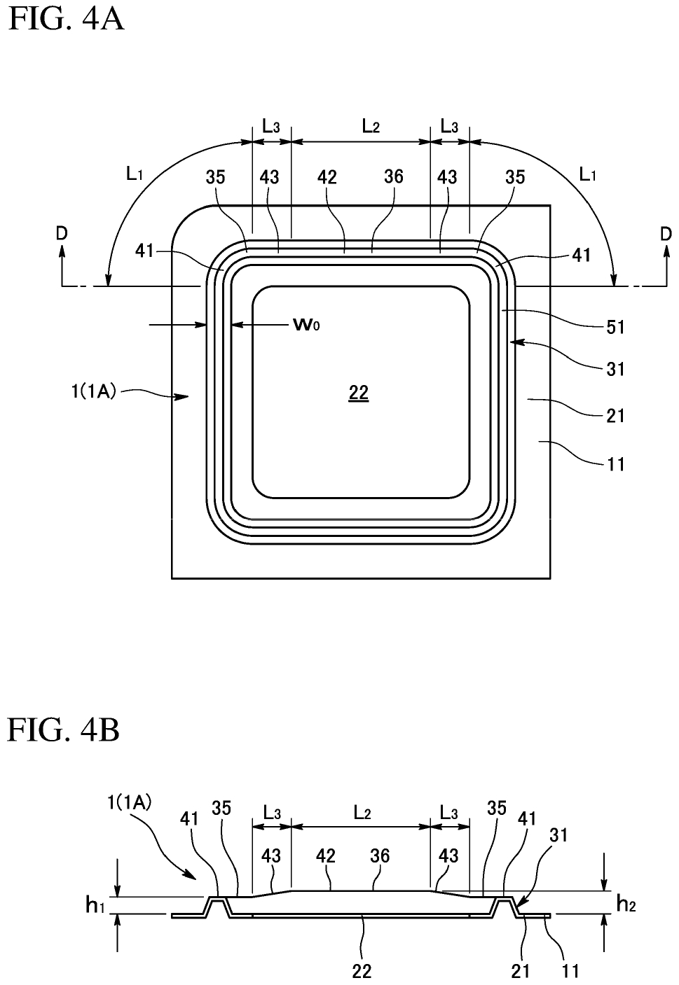

With reference to FIGS. 4A and 4B, a description will be given of a metal bead seal 1 according to a second embodiment. Note that, a detailed description of the structures similar to those according to the first embodiment will be omitted, and a description will be given mainly of the differences from the first embodiment. Note that, in FIG. 4B, the sealing rubber 51 is not illustrated for the sake of clarity.

The curved part 35 includes a minimum bead height part 41. The minimum bead height part 41 has a minimum bead height h₁ where the bead height is minimum on the circumference. The minimum bead height part 41 has a constant length range L₁ on the circumference, and is provided along the entire length (the entire angle) of the curved part 35.

The straight part 36 has a maximum bead height part 42. The maximum bead height part 42 has a maximum bead height h2 where the bead height is maximum on the circumference. The maximum bead height part 42 has a constant length range L₂ on the circumference, and is provided at the center in the length direction of the straight part 36.

Between the minimum bead height part 41 and the maximum bead height part 42, a gradually varying bead height part 43 is provided. The bead height of the gradually varying bead height part 43 gradually varies from the minimum bead height h₁ of the minimum bead height part 41 to the maximum bead height h₂ of the maximum bead height part 42. The gradually varying bead height part 43 has a constant length range L₃ on the circumference, and is provided at each of the opposite ends in the length direction of the straight part 36. Note that, part of the gradually varying bead height part 43 may be included in the curved part 35.

A width w₀ of the sealing bead 31 is constant over the entire circumference of the sealing bead 31.

In the following, a description will be given of the operation and effect of the metal bead seal 1 according to the present embodiment.

As in the conventional technique, when the cross-sectional shape of the sealing bead is completely the same on the circumference, the magnitude of the reactive force that occurs upon the compression of the sealing bead varies. Specifically, the reactive force increases at the curved part which is curved in a plan view and reduces at the straight part which is straight in a plan view.

On the other hand, in the sealing bead 31 according to the present embodiment, the curved part 35 includes the minimum bead height part 41 that has the minimum bead height; the straight part 36 includes the maximum bead height part 42 that has the maximum bead height; and the minimum bead height part 41 and the maximum bead height part 42 are smoothly connected to each other via the gradually varying bead height part 43.

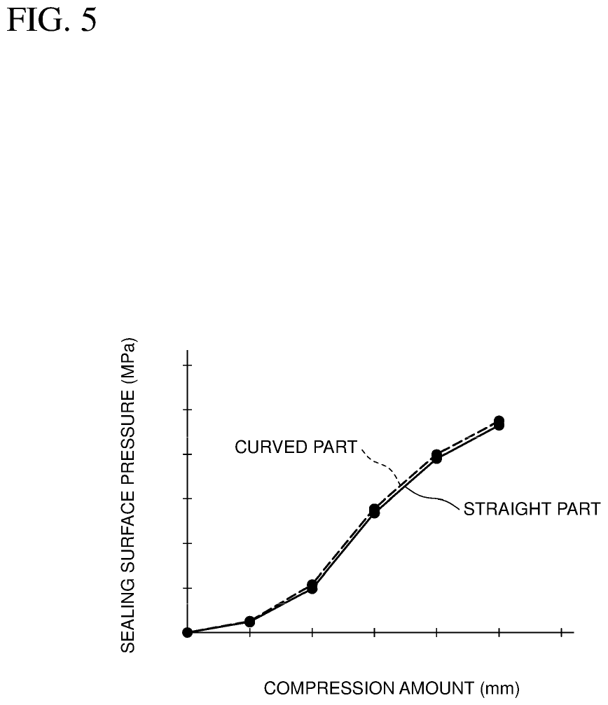

Accordingly, the magnitude of the reactive force occurring at the curved part 35 is smaller than in the conventional technique. Furthermore, the magnitude of the reactive force occurring at the straight part 36 is greater than in the conventional technique. This means that, with a constant width w₀, the occurring reactive force becomes smaller as the bead height is smaller, and the occurring reactive force becomes greater as the bead height is greater. As a result, as represented in the graph of FIG. 5, the magnitude of the reactive force occurring at the curved part 35 and the magnitude of the reactive force occurring at the straight part 36 approximate each other. Accordingly, the magnitude of the reactive force occurring at the sealing bead 31 upon compression becomes uniform as much as possible, which in turn provides uniform sealing surface pressure. This improves sealability.

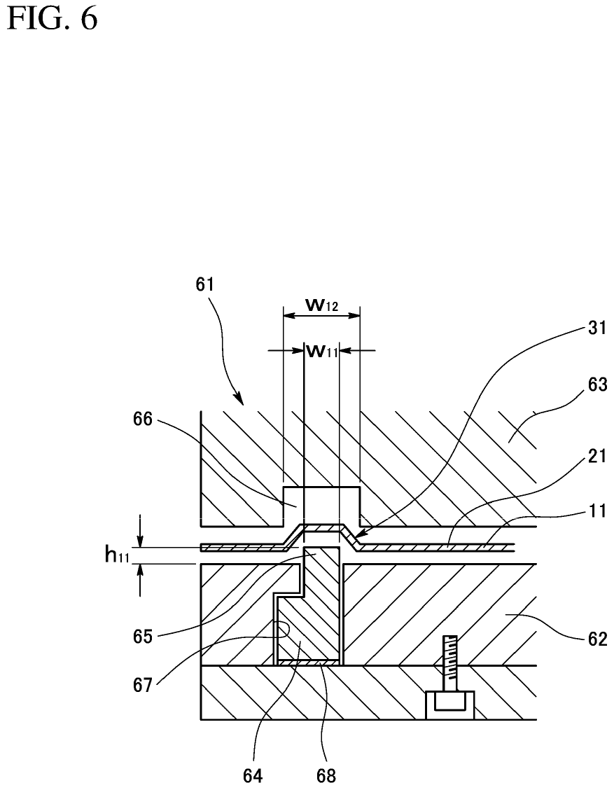

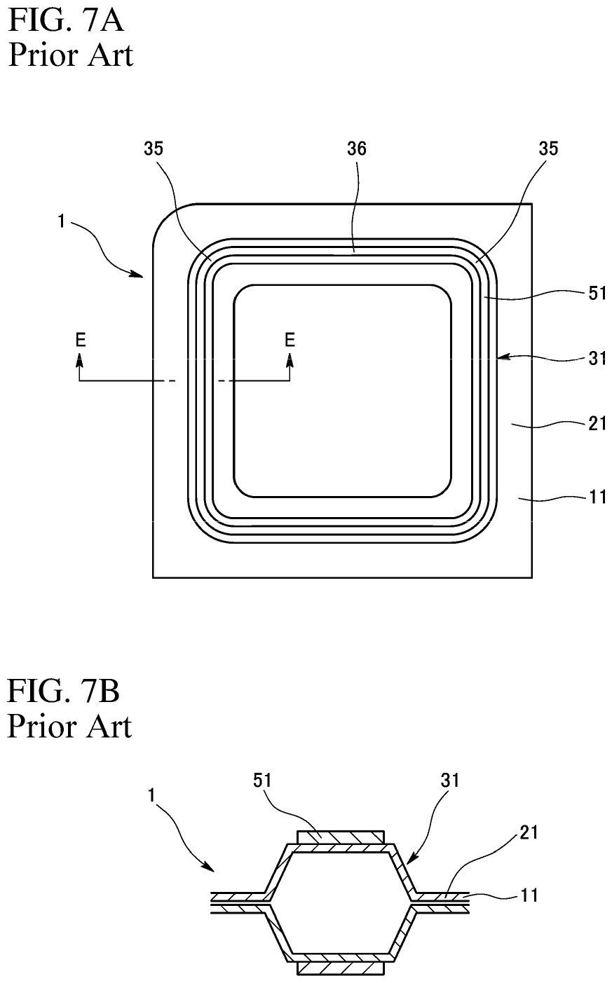

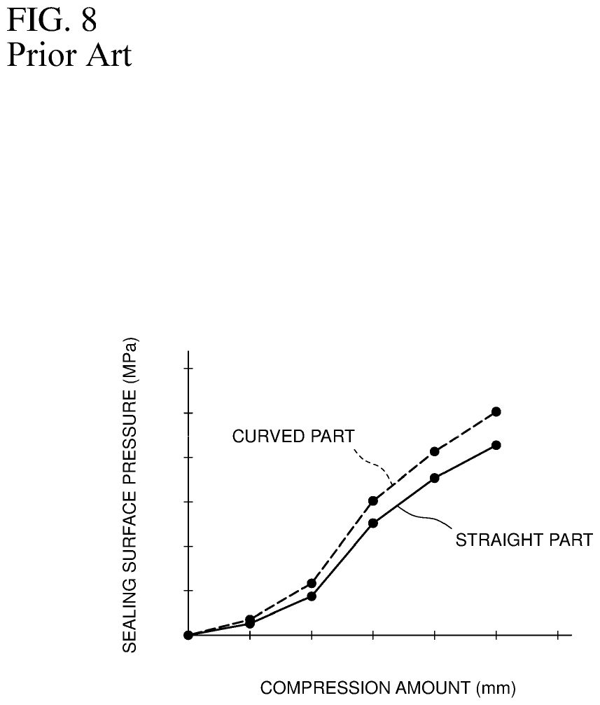

In the following, with reference to FIG. 6, a description will be given of a method of manufacturing the metal bead seal 1 according to the second embodiment. As illustrated in FIG. 6, using a press die assembly 61, a sealing bead 31 is formed at the metal plate 11.

The press die assembly 61 includes a first half die (lower die) 62 and a second half die (upper die) 63. In order to form the sealing bead 31 at the planar metal plate 11, an insert 64 including a press-purpose projecting part 65 is installed into the first half die 62. The second half die 63 is provided with a recessed part 66 as a receiver for the projecting part.

The width w₁₁ of the projecting part 65 and the width w₁₂ of the recessed part 66 are constant over the entire circumference. On the other hand, by providing a shim 68 at the position corresponding to the maximum bead height part 42 in the bottom surface part of the insert housing part 67 of the first half die 62, the height h₁₁ of the projecting part 65 becomes higher just at the portion where the shim 68 is provided when the die assembly is closed. The thickness of the shim 68 is the difference between the minimum bead height h₁ and the maximum bead height h₂. The thickness of the shim 68 is, for example, 0.05 mm. Thus, for example, when the height h₁₁ of the projecting part 65 at a portion without the shim 68 is 0.6 mm, the height h₁₁ of the projecting part 65 at a portion with the shim 68 becomes 0.65 mm.

By forming the sealing bead 31 at the plate 11 using the press die assembly 61 according to the present embodiment, the sealing bead 31 that has the minimum bead height part 41, the maximum bead height part 42, and the gradually varying bead height part 43 on the circumference is press formed. The present embodiment is particularly preferably applicable when the insert 64 has a constant height in the plane or the insert housing part 67 has a constant depth in the plane.

The first embodiment provides uniform reactive force by adjusting the bead width. The second embodiment provides uniform reactive force by adjusting the bead height. Furthermore, the first embodiment and the second embodiment may be practiced in combination.

1. A metal bead seal comprising:
a basal part made of metal; and
a sealing bead integrated with the basal part, the sealing bead including
a curved part that is curved in a plan view, the curved part including a maximum bead width part having a maximum bead width,
a straight part that is straight in a plan view and continuous from the curved part, the straight part including a minimum bead width part having a minimum bead width, and
a gradually varying bead width part that is positioned between the maximum bead width part and the minimum bead width part, the gradually varying bead width part having its bead width continuously varied from the maximum bead width to the minimum bead width.

2. The metal bead seal according to claim 1, wherein the sealing bead has a height that is constant over the entire circumference.

3. The metal bead seal according to claim 1, wherein
the curved part includes a minimum bead height part having a minimum bead height,
the straight part includes a maximum bead height part having a maximum bead height, and
the sealing bead includes a gradually varying bead height part positioned between the minimum bead height part and the maximum bead height part, the gradually varying bead height part having its bead height continuously varied from the minimum bead height to the maximum bead height.

4. A metal bead seal comprising:
a basal part made of metal; and
a sealing bead integrated with the basal part, the sealing bead including
a curved part that is curved in a plan view, the curved part including a minimum bead height part having a minimum bead height,
a straight part that is straight in a plan view and continuous from the curved part, the straight part including a maximum bead height part having a maximum bead height, and
a gradually varying bead height part positioned between the minimum bead height part and the maximum bead height part, the gradually varying bead height part having its bead height continuously varied from the minimum bead height to the maximum bead height.

5. The metal bead seal according to claim 4, wherein the sealing bead has a width being constant over its entire circumference.

6. The metal bead seal according to claim 1, further comprising a sealing rubber disposed between the sealing bead and a counterpart component.

7. A method of manufacturing the metal bead seal according to claim 1, comprising:
providing a press die that includes a recessed part having a width corresponding to the maximum bead width part, the minimum bead width part, and the gradually varying bead width part; and
press-forming a plate-like plate using the press die.

8. A method of manufacturing the metal bead seal according to claim 4, comprising:
providing a press die having a shim provided at a bottom surface of an insert housing part so as to correspond to the minimum bead height part, the maximum bead height part, and the gradually varying bead height part, and
press-forming a plate-like plate using the press die.

9. The method of manufacturing the metal bead seal according to claim 8, wherein the insert housing part has a constant depth within a plane.

10. A method of manufacturing a fuel cell, comprising installing the metal bead seal according to claim 1 into a fuel cell.

11. The metal bead seal according to claim 2, further comprising a sealing rubber disposed between the sealing bead and a counterpart component.

12. The metal bead seal according to claim 3, further comprising a sealing rubber disposed between the sealing bead and a counterpart component.

13. The metal bead seal according to claim 4, further comprising a sealing rubber disposed between the sealing bead and a counterpart component.

14. The metal bead seal according to claim 5, further comprising a sealing rubber disposed between the sealing bead and a counterpart component.

15. A method of manufacturing the metal bead seal according to claim 2, comprising:
providing a press die that includes a recessed part having a width corresponding to the maximum bead width part, the minimum bead width part, and the gradually varying bead width part; and
press-forming a plate-like plate using the press die.

16. A method of manufacturing the metal bead seal according to claim 5, comprising:
providing a press die having a shim provided at a bottom surface of an insert housing part so as to correspond to the minimum bead height part, the maximum bead height part, and the gradually varying bead height part, and
press-forming a plate-like plate using the press die.

17. A method of manufacturing a fuel cell, comprising installing the metal bead seal according to claim 4 into a fuel cell.
